(19) United States
(12) Patent Application Publication
(10) Pub. No.: US 2004/0161553 A1
(43) Pub. Date: Aug. 19, 2004

(54) Ink jet recording medium and ink jet recording medium preparing method

(75) Inventors: Yoshinori Tsubaki, Tokyo (JP); Masayuki Ushiku, Yokohama-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA MINOLTA HOLDINGS, INC., Tokyo (JP)

(21) Appl. No.: 10/770,619

(22) Filed: Feb. 2, 2004

(30) Foreign Application Priority Data
Feb. 10, 2003 (JP) JP2003-032240

(51) Int. Cl. B32B 3/00

(52) U.S. Cl. 428/32.1

(57) ABSTRACT

An ink jet recording medium comprising a support having thereon a porous layer containing micro particles of ground silica and a hydrophilic binder which is cross-linked with ionizing radiation, wherein the micro particles of ground silica have an average particle diameter of secondary particles of 10-300 nm.

### FIELD OF THE INVENTION

The present invention relates to an inkjet recording sheet (hereinafter, also simply referred to as a recording sheet) and a manufacturing method thereof, and particularly to an inkjet recording sheet and a manufacturing method thereof provided with a porous layer which results in prevention of cracks as well as improved resistance to creases and cracks of film.

### BACKGROUND OF THE INVENTION

In recent years, in an inkjet recording method, image quality has made rapid progress resulting in providing photographic image quality comparable to silver salt photography. To achieve such image quality of silver salt photography, rapid improvement of techniques also with an inkjet recording sheet employed is in progress.

As a support employed in an inkjet recording sheet, generally known are a water-absorptive support such as paper, and a non-water-absorptive support such as polyester and resin laminated paper. The former type is advantageous in being provided with a high ink absorption capability because of ability of the support itself to absorb ink while has problems of causing wrinkles (also referred to as cocklings) after printing due to the water-absorptive property of the support, which results in difficulty of obtaining a high quality print as well as easy production of scratches on the print surface with a head at the time of printing accompanied with cocklings. On the contrary, the latter type, in which non-water-absorptive support is employed, is advantageous in being free of aforementioned problems and obtaining a high quality print.

On the other hand, as an ink receiving layer, for example, there is known an inkjet recording sheet in which an ink receiving layer is formed by coating a hydrophilic binder such as gelatin and PVA on a support having high smoothness to make an ink absorbing layer. This type of recording sheet employs an ink absorption method utilizing swelling property of a binder, and is called as a swelling type ink-jet recording sheet.

The swelling-type ink-receiving layer has problems in that an ink drying property after printing is insufficient because of the binder being comprised of a hydrophilic resin, images and film are weak against moisture and poor in water resistance, in addition, an absorptive property by means of swelling of a binder cannot catch up to the ejection volume and the ejection rate of ink due to the fast printing speed of recent inkjet printers resulting in ink over flow or spottiness, which is inadequate for high speed printing.

An ink receiving layer comprising modified polyvinyl alcohol and a water-resistance enhancing agent is described in JP-A No. 63-18387 (hereinafter, JP-A refers to Japanese Patent Publication Open to Public Inspection). Further, there is proposed a recording sheet for water-based ink provided with an ink receiving layer comprising a hydrophilic resin having been cross-linked with ionizing radiation (for example, in JP-A No. 1-286886). In this way, water-resistance of images or film can be achieved by preparing an ink receiving layer comprised of a cured binder, however, the ink absorptive property has not been improved because ink absorption is substantially performed by means of swelling of the resin.

In contrast to the aforesaid swelling-type ink-jet recording sheet in which ink is absorbed utilizing a swelling property of a water-based resin, a porous-type ink-jet recording sheet provided with a porous layer having micro voids as an ink absorbing layer as described in JP-A No. 10-119423 exhibits a high ink absorptive property and a rapid drying property and is becoming one of the methods to provide image quality most similar to that of silver salt photography.

This porous layer is primarily comprised of a hydrophilic binder and micro-particles which include commonly known inorganic or organic micro-particles, and, generally, inorganic micro-particles are preferably utilized because of having smaller particle size and being able to form a porous layer having high glossiness.

By employing a relatively small amount of a hydrophilic binder vs. such inorganic micro-particles, voids are formed among inorganic micro-particles resulting in formation of a porous layer having a high void ratio.

The void portion has a merit of not damaging the absorption rate even when the water-resistance is enhanced by cross-linking of a binder incorporating such as a cross-linking agent because it absorbs ink based on a capillary phenomenon. Particularly, in the case of an inkjet recording sheet provided with a porous layer on a non water-absorptive support such as a polyethylene coat paper in which the both side of paper support have been laminated with polyethylene resin, the ink receiving layer has to be comprised of a porous layer having a high void volume because all of the ink has to be temporarily retained in an ink receiving layer at the time of inkjet recording. Therefore, it is necessary to form a heavily coated film having a high void ratio. Generally, it is at least 25 μm as a dry film thickness and specifically 30-50 μm.

In a porous layer having these characteristics, cracks are easily generated at the time of drying when a porous layer having a heavy layer thickness is coated on a non-water-absorptive support, because, the layer is generally comprised of inorganic micro-particles as the primary component and is basically a hard coated film.

During the manufacturing process of a porous layer, a small amount of a hydrophilic binder is adsorbed on the surface of micro-particles and gets coiled around each other among said hydrophilic binder or retains micro-particles by interaction of such as hydrogen bonding between the hydrophilic binder, which results in formation of a protective colloid to form a porous layer. Thereafter, rapid shrinkage during the drying process occurs and cracks are supposed to be produced on the film surface due to shrinking stress. Particularly, the phenomenon is significant at the vicinity of the end point of drying.

Therefore, it was necessary, to prepare an excellent coating film without producing such as cracks, that the film had to be dried under relatively mild conditions.

Further, in the ink-receiving layer after having been dried, there was a problem of poor water resistance since micro-particles were bound only with a relatively small amount of a hydrophilic binder.

With respect to these problems, an inkjet recording sheet in which water resistance of film was improved by utilizing boric acid and an isocyanate-type cross-linking agent has been proposed (for example, in JP-A No. 2001-146068), and an inkjet recording sheet employing an actinic ray curable monomer as the binder has been also proposed (for example, in JP-A No. 7-40649). On the other hand, proposed is an inkjet recording sheet provided with an ink absorptive layer and a gloss exhibiting layer successively, wherein the gloss exhibiting layer is primarily comprised of colloidal particles and a hydrophilic ionizing radiation curable compound having at least two ethylenic double bonds in one molecule which is cured by radiation of ionizing radiation (for example, in Japanese Patent No. 3333338).

In the case of incorporating a cross-linking agent in such hydrophilic binders or employing an actinic ray curable monomer as a binder, water resistance of the dried film may be improved, however, flexibility may be damaged, in addition, caused is a new problem of deteriorating resistance against creases and cracks of the film, because a high density of three dimensional cross-links in relatively short distances among binders are formed.

On the other hand, when interaction between inorganic micro-particles, specifically, silica micro-particles with a hydrophilic binder is noted, the mutual interaction can be explained by a hydrogen bonding between a silanol group on the surface of silica micro-particles and a hydrophilic group of the hydrophilic binder.

Silica with a gas phase method as one of silica micro-particles is characterized by the number of residual independent silanol groups on the silica surface, and gas phase method silica having many independent silanol groups had problems in that caused may be gelation or coagulation of the coating composition for preparing an ink receiving layer, due to excessively strong interaction with a hydrophilic binder, which results in poor adaptability for manufacturing.

### SUMMARY OF THE INVENTION

This invention has been made in view of the aforesaid problems, and the objective is to provide an inkjet recording sheet having a porous layer which hardly generates cracks at the time of manufacturing even when the porous layer comprising a hydrophilic binder and micro-particles is coated in a heavy thickness and at a high speed as well as is excellent in ink absorptive property, productivity and resistance against creases and cracks, and a manufacturing method thereof.

(Means to Solve the Problems)

The aforesaid problems can be solved by the following constitutions.

1. An inkjet recording sheet characterized by being provided with a porous layer containing wet-process silica having an average particle diameter of secondary particles of 10-300 nm and a hydrophilic binder having been cross-linked with ionizing radiation.

2. The inkjet recording sheet described in item 1, wherein aforesaid wet-process silica is synthesized with a gel method.

3. An inkjet recording sheet characterized by being provided with a porous layer containing silica micro-particles having a specific surface area measured with BET method of 40-100 m²/g and a coefficient of variation in the primary particle distribution of at most 0.4, and a hydrophilic binder having been cross-linked with ionizing radiation.

4. An inkjet recording sheet characterized by being provided with a porous layer containing gas phase method silica having a ratio of independent silanol groups of 0.5-2.0, and a hydrophilic binder having been cross-linked with ionizing radiation.

5. The inkjet recording sheet described in any one of items 1-4 above, wherein aforesaid hydrophilic binder having been cross-linked with ionizing radiation is a ionizing radiation cross-linking polymer of a hydrophilic binder having a degree of polymerization of at least 500 and a modification ratio of cross-linking groups of at most 4 mol %.

6. The inkjet recording sheet described in any one of items 1-5 above, wherein aforesaid support is a non water absorptive support.

7. A manufacturing method of the inkjet recording sheet described in any one of items 1-6 above, wherein a porous layer containing inorganic micro-particles and a ultraviolet ray curable hydrophilic binder are coated on said support, and then ultraviolet rays having an irradiation energy at a wavelength of 350 nm of 1-100 mJ/cm² are irradiated employing a metal halide lamp primary emission wavelength of which is 300-400 nm, followed by being dried to manufacture the ink jet recording sheet.

The inventors of this invention, as a result of extensive study in view of the aforesaid problems, have found that it is possible to provide an inkjet recording sheet having a porous layer which hardly generates cracks at the time of manufacturing even when the porous layer comprising a hydrophilic binder and micro-particles is coated in a heavy thickness and at a high speed as well as is excellent in ink absorptive property, productivity and resistance against creases and cracks; by being provided with a porous layer containing wet-process silica having an average particle diameter of secondary particles of 10-300 nm and a hydrophilic binder having been cross-linked with ionizing radiation; a porous layer containing silica micro-particles having a specific surface area measured with BET method of 40-100 m²/g and a coefficient of variation in the primary particle distribution of at most 0.4, and a hydrophilic binder having been cross-linked with ionizing radiation; or a porous layer containing gas phase method silica having a ratio of independent silanol groups of 0.5-2.0, and a hydrophilic binder having been cross-linked with ionizing radiation; and achieved this invention.

Further, as the manufacturing method of the ink-jet recording sheets comprised of the aforesaid constitutions of this invention, an inkjet recording sheet provided with the aforesaid characteristics can be obtained by coating a porous layer, and then irradiating ultraviolet rays having an irradiation energy at a wavelength of 350 nm of 1-100 mJ/cm² employing a metal halide lamp the primary wavelength of which is 300-400 nm, followed by being dried.

It has been found that the aforesaid effects can be exhibited more efficiently by employing wet-process silica synthesized with a gel method, a hydrophilic binder cross-linked by ionizing radiation having a degree of polymerization of at least 500 and the modification ratio of cross-linking groups of at most 4 mol %, and a non water-absorptive support as the support, in addition to the above constitution.

### DETAILED DESCRIPTION OF THE PREFERED EMBODIMENT

This invention will be detailed in the following.

The inkjet recording sheet of this invention is characterized in that a porous layer containing wet-process silica having an average particle diameter of secondary particles of 100-300 nm and a hydrophilic binder having been cross-linked with ionizing irradiation are provided on a support, and preferably employed is wet-process silica synthesized with a gel method.

Wet-process silica employed in this invention is synthesized by a precipitation method or a gel method using sodium silicate as a stating material; as wet-process silica by a precipitation method, for example, Fine Seal, manufactured by Tokuyama Corp., is available on the market, and as wet-process silica by a gel method, for example, Nipgel, manufactured by Nippon Silica Kogyo Co., Ltd., is available on the market. Silica by a precipitation method, and silica by a gel method are characterized by silica particles in which secondary coagulates are formed from primary particles of approximately 10-60 nm and of approximately 3-10 nm, respectively.

With respect to the primary particle diameter of wet-process silica, there is specifically no lower limit, however, it is preferably at least 3 nm in view of manufacturing stability of the particles, and the upper limit is preferably at most 50 nm in view of transparency of film. Generally, silica synthesized by a gel method is more preferable because the primary particle diameter of which tends to be smaller than that by a precipitation method.

Wet-process silica is featured by having no independent silanol groups, according to its characteristics. Therefore, in the coating solution in which the silica is mixed with a hydrophilic binder, the interaction with the hydrophilic binder is weak and the coating solution hardly causes gelation due to the interaction between the silica and the hydrophilic binder.

Each average particle diameter of the primary particles and secondary particles of silica micro-particles is determined by observing the cross-section or surface of the porous layer comprising said silica employing an electron microscope and measuring particle diameters of randomly selected 100 particles. Herein, an individual particle diameter is represented by a diameter of a supposed circle having an equivalent projected area.

To grind wet-process silica, employed can be, for example, such as a high pressure homogenizer, a high speed stirring homogenizer, a sand mill and an ultrasonic homogenizer, however, a sand mill is preferred in this invention. Beads employed in a sand mill are preferably zirconia beads of at most 1.0 mm and more preferably of at most 0.5 mm.

In this invention, an average particle diameter of the secondary particles after having been ground is preferably 10-300 nm with respect to transparency to ionizing radiation irradiated onto the coated film.

In the inkjet recording sheet of this invention, to employ gas phase method silica, having a specific area measured with BET method of 40-100 m²/g and a coefficient of variation in the primary particles of at most 0.4, as silica micro-particles is one of the characteristics, and an ink absorbing layer having a high void ratio can be formed by employing silica micro-particles having these characteristics. Silica micro-particles are not specifically limited provided that having aforesaid characteristics, however, gas phase method silica is preferred in this invention.

Gas phase method silica employed in this invention is one synthesized by a combustion method utilizing tetrachlorosilane and hydrogen as starting materials, and, for example, Aerosil Series, manufactured by Nippon Aerosil Co., Ltd., is available on the market.

In this invention, a specific surface area measured by BET method of silica micro-particles is preferably 40-100 m²/g, and the under limit of the specific surface area is 40 m²/g with respect to achieving glossiness comparable to that of silver salt photography.

BET method referred to in this invention is a method in which a specific surface area per 1 g of silica micro-particles is measured based on a gas phase absorption isotherm. In the gas phase silica having a specific surface area of a range specified in this invention, a coefficient of variation in the primary particle distribution is characterized by being at most 0.4 and preferably 0.01-0.4. In the case of the coefficient of variation exceeds 0.4, the void ratio liable to decrease, which is not preferable. Herein, in wet-process silica, it is not the case because the primary particles themselves are provided with micro bores.

Gas phase method silica is characterized by being able to be dispersed with a lower dispersing energy compared to wet-process silica, since the secondary coagulate is formed by relatively weak interaction compared to wet-process silica.

The coefficient of variation in the primary particle distribution of gas phase method silica according to this invention is determined by observing the cross-section and surface of the porous layer employing an electronmicroscope and measuring randomly selected 1000 primary particles to calculate the value of the standard deviation of the particle size distribution divided by a number average particle size. Herein, each particle diameter represents a diameter of a supposed circle having an equivalent projected area of the particle. Further, the average particle size of the secondary particles is preferably at most 300 nm with respect to transparency to ionized radiation.

The ratio of independent silanol groups referred to in this invention can be obtained by the following method employing FT-IR.

Gas phase method silica is dried at 120° C. for 24 hours, and is subjected to the measurement with FT-IR. Specifically, the absorbance at 3750 cm⁻¹ attributed to Si—OH and the absorbance at 1870 cm⁻¹ attributed to Si—O—Si are determined and the value calculated by the following equation is defined as a ratio of independent silanol groups.

Ratio of independent silanol groups=absorbance at 3750 cm⁻¹/absorbance at 1870 cm⁻¹

In this invention, a method to control the ratio of independent silanol groups of gas phase method silica is preferably to adjust the ratio by spraying water vapor on the gas phase method silica.

Specific methods to spray water vapor include such as a method in which water vapor is continuously sprayed while gas phase method silica is transferred and a method in which water vapor is sprayed while gas phase method silica is charged in a sealed batch and being subjected to aeration.

Further, also preferable is a method in which gas phase method silica is kept under an atmosphere having a humidity of 20-60% for at least 3 days to adjust the water content of the silica.

In the gas phase method silica according to this invention, one of the features is that the ratio of independent silanol groups is 0.5-1.5, and it is preferably 0.5-1.1. When the ratio of independent silanol groups is in this range, an ink absorptive layer having a high void ratio can be formed as well as gelation is restricted when the silica is added in a coating solution, due to the interaction with a hydrophilic binder, specifically the interaction between the independent silanol groups on silica micro-particles and modified polyvinyl alcohol.

In an ink absorptive layer according to this invention comprising each constitution specified above, the mechanism to achieve the high void ratio has not been clearly explained, however, the following each factor may be estimated.

1. When wet-process silica is employed, a high void ratio can be achieved due to micro bores contained in the primary particles of wet-process silica themselves in addition to micro bores formed among the secondary particles.

2. In gas phase method silica, the primary particles themselves are not provided with micro bores, however, gas phase method silica having a low specific surface area has a large secondary coagulate and the micro bore diameter among coagulated particles is wide. Therefore, the capillary pressure generated between the silica surface and water in the micro bore becomes low and film shrinkage is depressed resulting in formation of a porous layer provided with a high void ratio.

3. Gas phase method silica having a small specific surface area tends to have a small ratio of reactive independent silanol groups, while wet process silica has no independent silanol groups according to the characteristics. Therefore, a hydrogen bonding property among silica micro-particles or between silica micro-particles and a hydrophilic binder is decreased resulting in depression of shrinkage of the coated film to prepare a porous layer having a high void ratio.

4. When the size distribution of silica micro-particles is wide, the silica component having a higher specific surface area has an effect to fill in the micro bores formed among the secondary coagulated particles of the silica component having a lower specific surface area, resulting in prevention of achieving a high void ratio.

5. When the size distribution of the primary particles of silica micro-particles is wide, the size distribution of the secondary coagulates also necessarily becomes wide resulting in that silica micro-particles liable to exhibit a condensed packing structure that is a low void ratio structure.

The solid content of aforesaid each silica micro-particles in a water-soluble coating solution is preferably 5-40 weight % and more preferably 7-30 weight %.

In the inkjet recording sheet of this invention, one of the characteristics is that a porous layer contains a hydrophilic binder having been cross-linked with ionized radiation.

A hydrophilic resin being water-soluble and curable by ionizing radiation employed in a porous layer according to this invention is a water-soluble resin which is cured by causing reaction with ionizing radiation of such as ultraviolet rays, electron rays, α rays, β rays, γ rays, and X rays, and is water-soluble before the curing reaction but becomes substantially non-water-soluble after the curing reaction. However, said resin has a hydrophilic property to some extent even after curing and retains sufficient affinity with ink.

Such resins, for example, have two or more ethylenic double bonds in one molecule. Listed as ethylenic double bonds are such as a vinyl group, an acryloyl group, a methacryloyl group and an alycylic epoxy group, and such resins include unsaturated polyesters, modified unsaturated polyesters, acrylic polymers, acrylic oligomers, acrylic monomers, methacrylic polymers, methacrylic oligomers and mthacrylic monomers having said functional groups at the terminal or side chain; and polymers, oligomers, monomers and epoxy compounds having a vinyl-type unsaturated bond. Further, to adjust the curing property, it is preferable to blend monomers, oligomers and polymers having a mono-functional ethylenic double bond, and the blending ratio is preferably 50-1% based on the weight ratio against the compound having two or more ethylenic double bonds in one molecule.

Other examples include resins comprising hydrophilic resins such as PVA and having plural photo-reactive side chains in the main chain.

Such hydrophilic binders include polyvinyl alcohol (hereinafter, abbrebiated as PVA), polyethylene oxide, polyalkylene oxide, polyvinyl pyrrolidone, water-soluble polyvinyl acetal, poly-N-vinyl acetamide, polyacrylamide, polyacryloyl morpholine, polyhydroxy alkylacrylate, polyacrylic acid, hydroxyethyl cellulose, methyl cellulose, hydroxypropyl cellulose, gelatin, casein and water-soluble derivatives thereof; cross-linking modified polymers comprising a copolymer as the main chain, being reacted with side-chain modifying groups such as of a photo-dimerization type, a photo-degradation type, a photo-depolymerization type, a photo-modification type and a photo-polymerization type, and being cross-linked via a modified group with ionizing radiation such as ultraviolet rays and electron rays; or polymers, the main chain of which can directly cross-link; and among them preferable are cross-linking modified polymers.

Specifically preferable are cross-linking modified polymers having a modifying group of photo-polymerization type. The detailed reason for being preferable is not clear, however, it is estimated that the reaction dose not proceed chain-wise and is easily controllable, being different from conventional photo-polymerizing resins.

As ionizing radiation curable resins of a photo-dimerizing type, preferable are resins of a diazo type, or resins in which introduced is such as a cinnamoyl group, a stillbazonium group or a stillquinolium group.

Specifically, listed as photosensitive resins are compounds in which a stillbazonium group is introduced in the polyvinyl alcohol structure described in JP-A No. 60-129742, and are represented by following general formula (1).

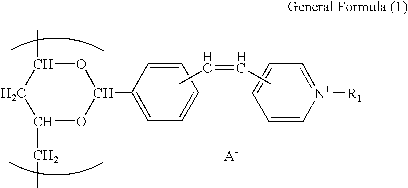

In general formula (1) above, R₁ represents an alkyl group having a carbon number of 1-4 and A⁻ represents an anionic group.

Further, listed as ionizing radiation curable resins of a photo-polymerization type are resins described in JP-A No. 2000-18106 and represented by following general formula (2).

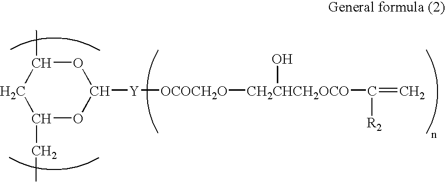

In general formula (2) above, R₂ represents a hydrogen atom or a methyl group and Y represents an aromatic ring or a single bond hand. “n” represents 1 or 2.

In hydrophilic binders according to this invention, the degree of polymerization of PVA which comprises the mother nucleus is preferably 500 or more, and is more preferably 1700 or more.

In hydrophilic binders according to this invention, the modification ratio of the ionizing radiation reactive cross-linking group per the segment is preferably 4 mol % or less and more preferably 0.01-1 mol %.

By employing the hydrophilic binders satisfying the conditions described above, a loose three dimensional cross-linking structure is formed to result in a high flexibility of the dried film prepared.

When the degree of polymerization of the segment is less than 500 or the modification ratio of the cross-linking groups is over 4 mol %, the resistance to creases and cracks of the coated film is significantly decreased.

Herein, in this invention, a hydrophilic resins commonly known may be used in combination within a range of not disturbing the effects of this invention.

In a porous layer according to this invention, the ratio of silica micro-particles to a hydrophilic binder is preferably 2-50 times based on a weight ratio. When the weight ratio is 2 or more times, the void ratio of the porous layer is preferable and a sufficient void capacity is easily obtained to result in prevention of the voids being clogged by swelling of an excess amount of a hydrophilic binder at the time of inkjet recording. While, in the case of the ratio being less than 50 times, it is preferable to hardly cause cracks when a porous layer is heavily coated. The Specifically preferable ratio of silica micro-particles to a hydrophilic binder is 2.5-20 times. Further, it is preferably 5-15 times, with respect to resistance against creases and cracks of the dried film.

A porous layer according to this invention is preferably provided with a capacity of 15-40 ml/m2 per a unit area of the film. The capacity referred herein is defined by a volume of foams which are generated when a unite volume of the coated film is immersed in water, a volume of water being absorbable by the coated film or a liquid transferred volume at a contact time of 2 seconds when the recording sheet finally obtained is subjected to the measurement based on the liquid absorption property test method specified in J. TAPPI 51.

As supports utilized in an inkjet recording sheet of this invention, employed can be a water-absorptive support (for example, such as paper) and a non water-absorptive support, and a non water-absorptive support is preferable with respect to obtaining prints of higher quality.

Non water-absorptive supports preferably utilized include, for example, such as transparent or opaque film comprising materials such as polyester type film, diacetate type film, triacetate type film, polyolefin type film, acrylic type film, polycarbonate type film, polyvinyl chloride type film, polyimide type film, cellophane and celluloid, or resin laminated paper in which the both surface of base paper are laminated with such as polyolefin resin, that is a so-called RC paper.

When the water-soluble coating solution described above is coated on the aforesaid support, it is preferable that the support surface is subjected to a corona-discharge treatment and/or an under-coat treatment for the purpose of enhancing adhesion strength between the surface and the coated layer. Further, an inkjet recording sheet may be comprising a support having been colored.

Supports preferably utilized in this invention are transparent polyester film, opaque polyester film, opaque polyolefin film and a paper support the both surface of which are laminated with polyolefin resin.

In the following, explained will be non-water-absorptive paper supports laminated with polyethylene as a typical example of polyolefin resin.

Base paper utilized in a paper support is wood pulp as a primary raw material, and paper supports are made into paper by appropriately adding synthetic pulp such as polypropylene or synthetic fiber such as nylon and polyester in addition to wood pulp. As wood pulp, for example, can be utilized is any of LBKP, LBSP, NBKP, NBSP, LDP, NDP, LUKP and NUKP, however, it is preferable to utilize more LBKP, NBSP, LBSP, NDP and LDP which are rich in short fiber. Herein, the content of LBSP or LDP is preferably 10-70 weight %.

As aforesaid pulp, chemical pulp (such as sulfate pulp and sulfite pulp) containing few impurities is preferably utilized and pulp subjected to a bleaching treatment to enhance whiteness is also useful.

Can be appropriately added in base paper are, for example, sizing agents such as a higher fatty acid and an alkylketene dimer, white pigments such as calcium carbonate, talk and titanium oxide, paper strength enhancing agents such as starch, polyacrylamide and polyvinyl alcohol, fluorescent brightening agents, moisture-retaining agents such as a polyethylene glycol series, dispesants, and softening agents such as quaternary ammonium.

The freeness of pulp utilized in paper making is preferably 200-500 ml based on the specification of CSF, and the length of fiber after beating is preferably 30-70% based on the sum weight % of a 24 mesh residue and a 42 mesh residue, specified in JIS-P-8207. Herein, the weight % of a 4 mesh residue is preferably at most 20 weight %.

The basis weight of base paper is preferably 30-250 g and specifically preferably 50-200 g. The thickness of base paper is preferably 40-250 μm. Base paper may be provided with high smoothness by being subjected to a calendar treatment, during or after the paper making stage. The base paper density is generally 0.7-1.2 g/m² (based on the specification of JIS-P-8118). Further, the base paper rigidity is preferably 20-200 g under conditions specified in JIS-P-8143. A surface sizing agent may be coated on the surface of base paper, and utilized as a surface sizing agent can be sizing agents similar to those can be added in the aforesaid base paper. The pH of base paper is preferably 5-9 when it is measured by a hot water extraction method specified in JIS-P-8113.

Polyethylene which laminates the front and back surfaces is primarily law density polyethylene (LDPE) or high density polyethylene (HDPE), however other polyethylene such as LLDPE and polypropyrene can be partly used.

Particularly, a polyethylene layer on the ink absorbing layer side is preferably one opacity and whiteness of which having been improved by adding titanium oxide of rutile or anatase type in polyethylene as is commonly applied in photographic print paper. The content of titanium oxide is generally 1-20 weight % and preferably 2-15 weight %, based on polyethylene.

Polyetylene laminated paper can be employed as glossy paper as well as paper provided with micro structure surfaces such as a matte surface or silky surface as obtained with conventional photographic print paper, which can be prepared by a so-called embossing treatment when polyethylene is coated by fusing extrusion on the base paper surface.

The using amounts of polyethylene on the front and back surfaces of base paper are selected so as to optimize curl under low and high humidity, and, generally, are in a rage of 20-40 μm for a polyethylene layer of the water-soluble coating composition side and 10-30 μm for that of the back layer side.

Further, the above-described polyethylene laminated paper support is preferably provided with the following characteristics.

(1) Tensile strength in the longitudinal direction is preferably 20-300 N and in the lateral direction is 10-200 N in terms of strength specified in JIS-P-8113.

(2) Tear strength in the longitudinal direction is preferably 0.1-2.0 N and in the lateral direction is 0.2-2.0 N in terms of strength specified in JIS-P-8116.

(3) Compressive elastic modulus is preferably at least 1030 N/cm².

(4) Surface Beck smoothness is preferably at shortest 500 seconds for a glossy surface under the conditions specified in JIS-P-8119, however, may be shorter than this for so-called embossed products.

(5) Back surface Beck smoothness is preferably 100-800 seconds under the conditions specified in JIS-P-8119.

(6) Opacity is preferably at most 20% and specifically preferably at most 15% under the measurement condition of direct incident light/diffusion light transmission.

(7) Whiteness is preferably at least 90% when it is measured as Hunter whiteness specified in JIS-P-8123. Further, L*=90−98, a*=−5−+5 and b*=−10−+5 are preferable when these are measured based on JIS-Z-8722 (non-fluorescent) and JIS-Z-8717 (containing fluorescent agents) and represented in terms of the color indication method specified in JIS-Z-8730.

Under-coat layer may be provided on the ink receiving layer side of the aforesaid support, for the purpose of enhancing adhesion with the ink-receiving layer. Binders for the under coat layer are preferably hydrophilic polymers such as gelatin and polyvinyl alcohol, and latex polymers having a Tg of −30-60° C. These binders are employed in a range of 0.01-2.0 g per 1 m² of a recording sheet. A small amount of an anti-static agent such as a cationic polymer which are commonly known may be incorporated in the under coat layer for the purpose of improving an anti-static property.

On the surface opposite to the ink receiving layer of the aforesaid support, a back layer may be provided on the purpose of improving a sliding property and an anti-static property. Binders for the back side layer are preferably hydrophilic polymers such as gelatin and polyvinyl alcohol, and latex polymers having a Tg of −30-60° C., and further, also added can be anti-static agents such as a cationic polymer, various kinds of surfactants in addition to matting agents having an average particle diameter of approximately 0.5-20 μm. The thickness of the back layer is generally 0.1-1.0 μm, however, it is approximately within a range of 1-20 μm when the back layer is provided for the purpose of anti-curling. Further, the back layer may be constituted of two or more layers.

Various kinds of additives can be incorporated in the water-soluble coating solutions which form an ink receiving layer and an ink absorptive layer according to this invention. Such additives include, for example, such as cationic mordants, cross-linking agents, surfactants (for example, cationic, nonionic, anionic or amphoteric surfactants), white back ground tone controlling agents, fluorescent whitening agents, anti-mold agents, viscosity controlling agents, low boiling-point organic solvents, high boiling-point organic solvents, latex emulsions, anti-fading agents, UV absorbents, polyvalent metallic compounds (being water-soluble or non-water-soluble), matting agents and silicon oils. Among them preferably employed is a cationic mordant with respect to improving water resistance and moisture resistance after printing.

As cationic mordants, preferably employed are mordants having primary to tertiary amino groups and a quaternary ammonium salt group, and preferable are polymer mordants having a quaternary ammonium salt group, because of minimum color change at long term storage nor deterioration of light fastness, and of high mordant capacity for dyes.

Preferable polymer mordants can be obtained as polymers comprising monomers having the aforesaid quaternary ammonium salt group alone or copolymers or condensed polymers thereof with other monomers.

Polyvalent metallic compounds utilizable in this invention are, for example, sulfates, chlorides, nitrates and acetates of such as Mg²⁺, Ca²⁺, Zn²⁺,Zr²⁺, Ni²⁺ and Al³⁺. Further, inorganic polymers of such as basic polyhydroxy aluminum and zirconium acetate are also listed as preferable examples of a water-soluble polyvalent metallic compound. Many of these water-soluble compounds are generally provided with functions of improving light fastness, bleeding resistance and water resistance. These water-soluble polyvalent metallic ions are employed in a range of approximately 0.05-20 mmol and preferably 0.1-10 mmol per 1 m² of the recording sheet.

In manufacturing of an inkjet recording sheet of this invention, preferably employed as a coating method at the time of coating an ink receiving layer coating solution on a support is, for example, a graveure coating method, a roll coating method, a rod-bar coating method, an air-knife coating method, a spray coating method, an extrusion coating method, a curtain coating method or an extrusion coating method which employs the hopper described in U.S. Pat. No. 2,681,294.

The porous layer according to the recording sheet of this invention may comprise either a single layer or two or more layers, and when it comprises two or more layers, preferred is a method to coat the all constituent layers simultaneously with respect to improving productivity.

The manufacturing method of a recording sheet of this invention explained above is characterized in that a hydrophilic binder having been cross-linked with an ionizing radiation is provided in a porous layer, and the hydrophilic binder is cured by irradiation with UV rays having an irradiation energy at a wavelength of 350 nm of 0.1-100 mJ/cm² employing a metal halide lamp having a primary emission wavelength of 300-400 nm after the porous layer having been coated, followed by drying the coated layer.

Ionizing radiation referred in this invention includes, for example, such as electron rays, ultraviolet rays, α rays, β rays, γ rays and X rays, and preferred are ultraviolet rays which are safe to humane body and easily handled as well as prevailing in industrial applications.

For example, utilized as a light source are such as a low-pressure, middle-pressure or high-pressure mercury lamp, and a metal halide lamp having a working pressure of from a few kPa to a few Mpa, however, preferable is a high pressure mercury lamp or a metal halide lamp with respect to wavelength distribution of the light source, and a metal halide lamp is specifically preferred. Further, it is preferable to provide a filter to cut the light having wavelengths of shorter than 300 nm. The output power of a lamp is preferably 400 W-30 kW, and the illuminance is 10 mW/cm²-10 kW/cm²; this invention is characterized by the irradiation energy being 0.1-100 mJ/cm², and more preferably 1-50 mJ/cm².

In the case that ultraviolet rays of shorter than 300 nm are included in the wavelength of a light source or the irradiation energy is over 100 J/cm², it is not preferable because the mother nuclei of an ionizing radiation curable resin or various types of additives incorporated may decompose by the ionizing radiation to result in being unable to achieve the effects of this invention in addition to possibility of causing problems of such as odor due to decomposed products. Further, in the case that the irradiation energy is less than 0.1 mJ/cm², the cross-linking efficiency is insufficient which results in not to achieve the effects of this invention sufficiently.

In an inkjet recording sheet of this invention, it is preferable to incorporate such as a photo-polymerization initiator and a photo-sensitizing agent. These compounds may be dissolved or dispersed in a solvent, or chemically bonded to a hydrophilic binder which can be cross-linked by ionizing radiation.

Photo-polymerization initiators and photo-sensitizing agents usable in this invention are not specifically limited, and utilized can be conventional compounds commonly known.

Photo-polymerization initiators and photo-sensitizing agents include, for example, benzophenone series (such as benzophenone, hydroxy benzophenone, bis-N,N-dimethylamino benzophenone, bis-N,N-diethylamino benzophenone and 4-methoxy-4′-dimethylamino benzophenone), thioxantone series (such as thioxantone, 2,4-diethyl thioxantone, isoproryl thioxantone, chlorothioxantone, isopropoxy chlorothioxantone), anthraquinone series (such as ethylanthraquinone, benzanthraquinone, aminoanthraquinone and chloroanthraquinone), acetophenone series, benzoin ether series (such as benzoin methylether), 2,4,6-trihalomethyl triazine series, 1-hydroxycyclohexyl phenylketone, 2-(o-chlorophenyl)-4,5-diphenyl imidazol dimer, 2-(o-chlorophenyl)-4,5-di(m-methoxyphenyl) imidazol dimer, 2-(o-fuluorophenyl)-4,5-diphenyl imidazol dimer, 2-(o-methoxyphenyl)-4,5-diphenyl imidazol dimer, 2-(p-methoxyphenyl)-4,5-diphenyl imidazol dimer, 2-di(p-methoxyphenyl)-5-phenyl imidazol dimer, 2-(2,4-dimethoxyphenyl)-4,5-diphenyl imidazol dimer, 2,4,5-triaryl imidazol dimer, benzyldimethylketal, 2-benzyl-2-dimethylamino-1-(4-morpholinophenyl)-butane-1-one, 2-methyl-1-[4-(methylthio)phenyl]-2-morpholino-1-propanone, 2-hydroxy-2-methyl-1-phenyl-propane-1-one, 1-[4-(2-hydroxyethoxy)-phenyl]-2-hydroxy-2-methyl-1-propane-1-one, phenanthrene quinone, 9,10-phenanthrene quinone, benzoine series (such as methylbenzoine and ethylbenzoine), acridine derivatives (such as 9-phenyl acridine, 1,7-bis(9.9′-acridinyl)heptane) and bisacylphosphineoxide; and aforesaid compounds may be utilized alone or in combination.

Polymerization accelerators in addition to aforesaid photo-polymerization initiators can be incorporated. Polymerization accelerators can include, for example, such as p-dimethylamino ethyl benzoate, p-dimethylamino isoamyl benzoate, ethanol amine, diethanol amine and triethanol amine.

### EXAMPLES

The effects of this invention will be explained below in reference to examples, however, this invention is not limited to these examples. Herein, “%” in the examples represents weight % except otherwise noted.

<Preparation of Silica Dispersion Solution>

After each silica micro-particles described in Table 1 was gradually added into a 1% ethanol aqueous solution, stirred, dispersed employing a high-speed stirring homogenizer, the pH of the solution being adjusted to 4.0, and pure water was added to make 100% which results in each dispersion solution containing 25% solid of silica micro-particles.

Next, each dispersion solution was dispersed so as to make the average secondary particle size of silica micro-particles described in Table 1 by appropriately controlling the dispersing time of a sand mill to prepare silica dispersion solutions S-1-S-10. Successively, the dispersion solutions prepared were filtered employing a filter of TCP-10 type, manufactured by Advantex Toyo Co., Ltd.

Herein, S-8 was prepared by mixing Aerosil 50 (an average primary particle diameter of 30 nm) and Aerosil OX50 (an average primary particle diameter of 40 nm), which were manufactured by Nippon Aerosil Co., Ltd. and adjusting the mixing ratio to make the coefficient of variation of the primary particle distribution described in Table 1.

Average secondary particle diameters of the silica micro-particles in the silica dispersion solutions described in Table 1 were determined by diluting each silica dispersion solution by 50 times and employing a dynamic light scattering type particle size measuring apparatus, Zetasizer 100 (manufactured by Malvern Co., Ltd.).

Further, the ratio of independent silanol groups of gas phase method silica employed for the preparation of the aforesaid silica dispersion was adjusted to make the ratio of independent silanol groups described in Table 1 by being appropriately stored under environment of a temperature of 30° C. and a relative humidity of 60% for 1-7 days.

Further, the specific surface area of gas phase method silica was measured with a method in which the specific surface area per 1 g of gas phase method silica was determined from the gas phase adsorption isotherm by means of BET method.

TABLE 1

| | Type and characteristics of silica micro-particles | | | | | | | |
|---|---|---|---|---|---|---|---|---|
| | | | | Average | | | Ratio | Average |
| Silica | | | | primary | | | of | secondary |
| dipersion | | | | particle | Specific | | independent | particle |
| solution | Type of | Product | | size | area | | silanol | size |
| No. | silica | name | Manufacturer | (nm) | (m²/g) | *1 | group | (nm) |
| S-1 | Ppt. method | Nipsil | Nippon | 70 | 174 | 0.28 | 0 | 156 |
| | wet-process | E743 | Silica Ind. | | | | | |
| | | | Co., Ltd. | | | | | |
| S-2 | Ppt. method | Nipsil | Nippon | 70 | 142 | 0.42 | 0 | 328 |
| | wet-process | E743 | Silica Ind | | | | | |
| | | | Co., Ltd. | | | | | |
| S-3 | Gel method | Nipgel | Nippon | 10 | 170 | 0.3 | 0 | 187 |
| | wet-process | AZ200 | Silica Ind. | | | | | |
| | | | Co., Ltd. | | | | | |
| S-4 | Gel method | Nipgel | Nippon | 10 | 153 | 0.4 | 0 | 343 |
| | wet-process | AZ200 | Silica Ind. | | | | | |
| | | | Co., Ltd. | | | | | |
| S-5 | Gas phase | Aerosil | Nippon | 12 | 200 | 0.1 | 0.8 | 50 |
| | method | 200 | Aerosil Co. | | | | | |
| | | | Ltd. | | | | | |
| S-6 | Gas phase | Aerosil | Nippon | 12 | 200 | 0.1 | 2.5 | 50 |
| | method | 200 | Aerosil Co. | | | | | |
| | | | Ltd. | | | | | |
| S-7 | Gas phase | Aerosil | Nippon | 30 | 59 | 0.25 | 0.9 | 70 |
| | method | 50 | Aerosil Co. | | | | | |
| | | | Ltd. | | | | | |
| S-8 | Gas phase | Aerosil | Nippon | 30 | 59 | 0.5 | 0.9 | 70 |
| | method | 50 | Aerosil Co. | | | | | |
| | | | Ltd. | | | | | |
| S-9 | Gas phase | Aerosil | Nippon | 7 | 300 | 0.1 | 0.8 | 45 |
| | method | 300 | Aerosil Co. | | | | | |
| | | | Ltd. | | | | | |
| S-10 | Gas phase | Fineseal | Tokuyama | 50 | 50 | 0.2 | 1.2 | 80 |
| | method | QS-07 | Corp. | | | | | |

*1; Coefficient of variation of primary particle size distribution

<Preparation of Recording Sheet>

[Preparation of Recording Sheets A-1-A-10]

An aqueous solution of an ultraviolet ray polymerizing polyvinyl alcohol derivative (being represented by general formula (2), a degree of polymerization of primary chain PVA is 3000, a saponification degree of 88%, modifying ratio of cross-linking groups of 1 mol %) having a concentration of 10% of 25 g and 0.05 g of a photo-polymerization initiator (Kayacure QTX, manufactured by Nippon Kayaku Co., Ltd.) were added gradually while being stirred into silica dispersion solutions S-1 to S-10 prepared above, and the resulting solution was made up to 200 g with pure water to prepare an ink receiving layer coating solution.

Next, the aforesaid ink receiving layer coating solution was coated on a polyethylene coat paper in which the both sides of the base paper were laminated with polyethylene of 170 g/m² thick (8% of anatase type titanium oxide being contained in the ink receiving layer side polyethylene, provided with a gelatin under-coat layer of 0.05 g/m² on the ink receiving layer side surface, and provided with a back layer containing latex polymer having a Tg of 80° C. on the surface opposite to the ink receiving layer) at a wet film thickness of 180 μm employing a bar coater, then an ultraviolet rays having an energy of 30 mJ/cm² was irradiated employing a metal halide lamp having a primary irradiation wavelength of 365 nm and equipped with a filter to cut the wavelengths shorter than 300 nm (365 Filter, produced by Iwasaki Electric Co., Ltd.), followed by being dried with a hot air type oven at 80° C. to prepare recording sheets A-1-A-10.

[Preparation of Recording Sheets B-1-B-10]

Recording sheets B-1-B-10 were prepared in a similar manner to aforesaid recording sheets A-1-A10, except that the polymerization degree of the main chain PVA of the ultraviolet ray polymerizing polyvinyl alcohol derivative utilized was changed to 400.

[Preparation of Recording Sheets C-1-C-10]

Recording sheets C-1-C-10 were prepared in a similar manner to aforesaid recording sheets A-1-A10, except that the modification ratio of cross-linking groups of the ultraviolet ray polymerizing polyvinyl alcohol derivative utilized was changed to 5.0 mol %.

[Preparation of Recording Sheets D-1°-D-10]

Recording sheets D-1-D-10 were prepared in a similar manner to aforesaid recording sheets A-1-A10, except that ultraviolet rays having an energy of 110 mJ/cm² were irradiated employing a low-pressure mercury lamp a primary wavelength of which is 254 nm, as the irradiation conditions of ionizing radiation.

[Preparation of Recording Sheets E-1-E-10]

Recording sheets E-1-E-10 were prepared in a similar manner to aforesaid recording sheets A-1-A10, except that polyvinyl alcohol (polymerization degree of 3000, saponification degree of 88%) was used in stead of the ultraviolet ray polymerizing polyvinyl alcohol derivative, in addition, 0.03 g of boric acid is added, and irradiation of ultraviolet rays was not performed.

[Preparation of Recording Sheets F-1-F-10]

Recording sheets F-1-F-10 were prepared in a similar manner to aforesaid recording sheets A-1-A10, except that polyvinyl alcohol (polymerization degree of 3000, saponification degree of 88%) was used in stead of the ultraviolet ray polymerizing polyvinyl alcohol derivative and irradiation of electron rays having a acceleration voltage of 100 kV and an output power of 50 kGly was prerformed instead of irradiation of ultraviolet rays.

[Preparation of Recording Sheets G-1-G-10]

Recording sheets G-1-G-10 were prepared in a similar manner to aforesaid recording sheets A-1-A10, except that compounds having ethylenic unsaturated double bonds, 20 g of NK Oligo UA-7100, and 5 g of NK Ester E-30G, which were manufactured by Shin-Nakamura Chemicals Co., Ltd., and 0.05 g of a photo-polymerization initiator (Kayacure QTX, manufactured by Nippon Kayaku Co., Ltd.) were added in stead of the ultraviolet ray polymerizing polyvinyl alcohol derivative.

Successively, each recording sheet prepared above was stabilized by being stored at 40° C. for 3 days after preparation.

<Evaluation of Each Characteristic of Recording Sheet>

With respect to each recording sheet prepared above, each evaluation was performed according to the following methods.

[Evaluation of Smoothness]

The center line surface roughness (being measured at standard length of 2.5 mm and a cut off value of 0.8 mm) was determined according to the method specified in JIS-B-0601 with respect to the ink receiving layer surface of each recording sheet prepared above and evaluation of smoothness was performed based on the following criteria.

A: The center line surface roughness Ra is less than 1.0 μm, and beauty is not spoiled.

B: The center line surface roughness Ra is 1.0-1.5 μm, and beauty is not spoiled.

C: The center line surface roughness Ra is 1.5 μm or more, and beauty is spoiled to be problematic in practical use.

D: Many cracks on the coated film surface are visually observed and the recording sheet does not fit for practical use.

In the above evaluation ranks, ranks A and B were judged to be the quality allowed in practical use.

[Evaluation of Crack Resistance]

The ink receiving layer surface of each recording sheet prepared above was observed through a loupe to count the number of cracks generated in the film surface of 10 cm², which was designated as a measure of crack resistance.

[Evaluation of Ink Absorptive Property]

A neutral gray solid image having a reflection density of approximately 1.0 was printed on the whole surface employing Inkjet Printer PM900C, produced by Seiko Epson Co., Ltd., and the ink absorptive property was evaluated based on the following criteria.

A: No unevenness is observed in the solid image surface.

B: Slight unevenness is observed in the solid image surface, however, the quality is no problem in practical use.

C: Discriminable unevenness is observed when the solid image surface is carefully observed, however, the quality is no problem in a practical print.

D: Distinct gray color shading in the solid image surface is observed, and the quality of the sample cannot be allowed in practical use.

E: Significant color shading in the solid image surface is observed, and the quality of the sample cannot be allowed at all in practical use.

In the above evaluation ranks, C or the better ranks were judged to be the quality allowed in practical use.

[Evaluation of Resistance against Creases and Cracks]

Each above recording sheet was cut into a narrow tablet form having a size of 5×10 cm, being wound under conditions of 23° C. and 55% RH, around a paper pipe having a inner diameter of 3 cm so as to make the ink receiving layer outside, then it was detached after 1 hour to be observed on the ink receiving layer side surface through a loupe, and the number of cracks generated due to creases and cracks was counted to perform the evaluation of resistance to creases and cracks based on the following criteria.

A: No creases and cracks are observed.

B: The number of creases and cracks generated is 1-5.

C: The number of creases and cracks generated is 6-19.

D: The number of creases and cracks generated is 20-99.

E: The number of creases and cracks generated is 100 or more.

In the above evaluation ranks C or the better ranks were judged to be the quality allowed in practical use.

[Evaluation of Dimensional Stability]

Each recording sheet was cut into a A4 size, being kept on a horizontal table under conditions of 23° C. and a relative humidity of 20% for one day, and measured were curl heights at the four corners (being lifted up), the average values of which were compared to the following criteria to determine the dimensional stability (mm). Herein, each recording sheet was kept in the direction in which the four corners were lifted up, the dimensional stability represented the state in which the four corners were lifted up when the ink receiving surface was up.

A: less than 3 mm

B: at least 3 mm and less than 10 mm

C: at least 10 mm and less than 30 mm

D: at least 30 mm

E: The sample is in a cylindric state and the curl was unable to be measured

[Evaluation of Maximum Density (Coloring Property)]

The black maximum density was printed employing Ink-jet Printer PM900C produced by Seiko Epson Co., Ltd., and the density was measured.

Each evaluation result obtained above is shown in Table 2. Herein, *1 described in Table 2 indicates that the coating solution was gelled at the preparation of the recording sheet resulting in making the coating impossible.

TABLE 2-1

| | | Evaluation results | | | | | | |
|---|---|---|---|---|---|---|---|---|
| | | | | | Resistance | | | |
| | | | | | to | | | |
| | Silica | | | Ink | creases | | | |
| Recording | dispersion | | Crack | absorptive | and | Dimensional | Black | |
| sheet | solution | Smoothness | resistance | property | cracks | stability | density | Remarks |
| A-1 | S-1 | A | 1 | B | A | A | 2.18 | Inv. |
| A-2 | S-2 | A | 25 | C | D | A | 1.86 | Comp. |
| A-3 | S-3 | A | 0 | A | A | A | 2.23 | Inv. |
| A-4 | S-4 | A | 20 | C | D | A | 1.88 | Comp. |
| A-5 | S-5 | A | 0 | A | A | A | 2.39 | Inv. |
| A-6 | S-6 | *1 | *1 | *1 | *1 | *1 | *1 | Comp. |
| A-7 | S-7 | A | 0 | A | A | A | 1.92 | Inv. |
| A-8 | S-8 | A | 0 | D | A | A | 1.98 | Comp. |
| A-9 | S-9 | A | 0 | A | A | A | 2.48 | Inv. |
| A-10 | S-10 | A | 0 | A | A | A | 1.9 | Inv. |
| B-1 | S-1 | A | 14 | C | B | B | 2.17 | Inv. |
| B-2 | S-2 | A | 28 | D | D | C | 1.88 | Comp. |
| B-3 | S-3 | A | 12 | C | B | B | 2.24 | Inv. |
| B-4 | S-4 | A | 24 | D | D | C | 1.86 | Comp. |
| B-5 | S-5 | A | 12 | C | B | B | 2.38 | Inv. |
| B-6 | S-6 | *1 | *1 | *1 | *1 | *1 | *1 | Comp. |
| B-7 | S-7 | A | 7 | C | B | B | 1.91 | Inv. |
| B-8 | S-8 | A | 21 | C | D | C | 1.94 | Comp. |
| B-9 | S-9 | A | 28 | B | B | B | 2.43 | Inv. |
| B-10 | S-10 | A | 8 | C | B | B | 1.87 | Inv. |

Inv.; Invention
Comp.; Comparison

TABLE 2-2

| | | Evaluation results | | | | | | |
|---|---|---|---|---|---|---|---|---|
| | | | | | Resistance | | | |
| | | | | | to | | | |
| | Silica | | | Ink | creases | | | |
| Recording | dispersion | | Crack | absorptive | and | Dimensional | Black | |
| sheet | solution | Smoothness | resistance | property | cracks | stability | density | Remarks |
| C-1 | S-1 | A | 18 | A | C | B | 2.15 | Inv. |
| C-2 | S-2 | A | 49 | B | E | C | 1.89 | Comp. |
| C-3 | S-3 | A | 11 | B | C | B | 2.22 | Inv. |
| C-4 | S-4 | A | 47 | A | E | C | 1.88 | Comp. |
| C-5 | S-5 | A | 16 | A | C | B | 2.39 | Inv. |
| C-6 | S-6 | *1 | *1 | *1 | *1 | *1 | *1 | Comp. |
| C-7 | S-7 | A | 18 | A | C | B | 1.86 | Inv. |
| C-8 | S-8 | A | 27 | A | E | C | 1.87 | Comp. |
| C-9 | S-9 | A | 52 | A | C | B | 2.41 | Inv. |
| C-10 | S-10 | A | 21 | A | C | B | 1.81 | Inv. |
| D-1 | S-1 | A | 11 | B | C | B | 2.09 | Inv. |
| D-2 | S-2 | B | 38 | C | E | B | 1.79 | Comp. |
| D-3 | S-3 | A | 7 | A | C | B | 2.16 | Inv. |
| D-4 | S-4 | B | 31 | B | E | B | 1.78 | Comp. |
| D-5 | S-5 | A | 4 | A | C | B | 2.31 | Inv. |
| D-6 | S-6 | *1 | *1 | *1 | *1 | *1 | *1 | Comp. |
| D-7 | S-7 | A | 8 | A | C | B | 1.82 | Inv. |
| D-8 | S-8 | B | 16 | A | E | B | 1.84 | Comp. |
| D-9 | S-9 | A | 7 | A | C | B | 2.36 | Inv. |
| D-10 | S-10 | B | 5 | A | C | B | 1.77 | Inv. |

Inv.; Invention
Comp.; Comparison

TABLE 2-3

| | | Evaluation results | | | | | | |
|---|---|---|---|---|---|---|---|---|
| | | | | | Resistance | | | |
| | | | | | to | | | |
| | Silica | | | Ink | creases | | | |
| Recording | dispersion | | Crack | absorptive | and | Dimensional | Black | |
| sheet | solution | Smoothness | resistance | property | cracks | stability | density | Remarks |
| E-1 | S-1 | B | 11 | C | E | B | 2.19 | Comp. |
| E-2 | S-2 | C | 49 | B | E | C | 1.87 | Comp. |
| E-3 | S-3 | B | 5 | C | E | B | 2.25 | Comp. |
| E-4 | S-4 | C | 42 | B | E | C | 1.92 | Comp. |
| E-5 | S-5 | C | 89 | B | E | B | 2.38 | Comp. |
| E-6 | S-6 | *1 | *1 | *1 | *1 | *1 | *1 | Comp. |
| E-7 | S-7 | C | 61 | B | E | B | 1.94 | Comp. |
| E-8 | S-8 | C | 65 | E | E | C | 1.91 | Comp. |
| E-9 | S-9 | C | 98 | B | E | B | 2.46 | Comp. |
| E-10 | S-10 | C | 44 | B | E | B | 1.89 | Comp. |
| F-1 | S-1 | A | 2 | C | B | B | 2.22 | Inv. |
| F-2 | S-2 | A | 24 | B | D | C | 1.84 | Comp. |
| F-3 | S-3 | A | 1 | C | B | B | 2.23 | Inv. |
| F-4 | S-4 | A | 21 | B | D | C | 1.85 | Comp. |
| F-5 | S-5 | A | 1 | B | B | B | 2.38 | Inv. |
| F-6 | S-6 | *1 | *1 | *1 | *1 | *1 | *1 | Comp. |
| F-7 | S-7 | A | 2 | B | B | B | 1.91 | Inv. |
| F-8 | S-8 | A | 3 | E | D | C | 1.96 | Comp. |
| F-9 | S-9 | A | 1 | B | B | B | 2.45 | Inv. |
| F-10 | S-10 | A | 2 | B | B | B | 1.92 | Inv. |

Inv.; Invention
Comp.; Comparison

TABLE 2-4

| | | Evaluation results | | | | | | |
|---|---|---|---|---|---|---|---|---|
| | | | | | Resistance | | | |
| | | | | | to | | | |
| | Silica | | | Ink | creases | | | |
| Recording | dispersion | | Crack | absorptive | and | Dimensional | Black | |
| sheet | solution | Smoothness | resistance | property | cracks | stability | density | Remarks |
| G-1 | S-1 | A | 11 | B | B | C | 2.21 | Inv. |
| G-2 | S-2 | B | 23 | C | D | C | 1.81 | Comp. |
| G-3 | S-3 | A | 7 | B | B | C | 2.24 | Inv. |
| G-4 | S-4 | A | 14 | C | D | C | 1.83 | Comp. |
| G-5 | S-5 | A | 5 | A | C | C | 2.32 | Inv. |
| G-6 | S-6 | A | 10 | A | C | C | 2.3 | Comp. |
| G-7 | S-7 | A | 19 | A | C | C | 1.89 | Inv. |
| G-8 | S-8 | A | 5 | D | C | C | 1.86 | Comp. |
| G-9 | S-9 | A | 20 | A | D | C | 2.41 | Inv. |
| G-10 | S-10 | A | 6 | B | B | C | 1.93 | Inv. |

Inv.; Invention
Comp.; Comparison

It is clear from Table 2-1 to 2-4 that the recording sheet of the present invention which employs, together with a hydrophilic binder cross-linked with ionizing radiation, wet process silica having an average secondary particle size of 10-300 nm, silica micro-particles having a specific surface area measured by BET method of not less than 40 m²/g and less than 100 m²/g as well as the coefficient of variation of primary particle distribution of at most 0.4, or gas phase method silica having a ratio of independent silanol groups of 0.5-2.0 is superior in any of smoothness, crack resistance, ink absorptive property, and resistance against creases and cracks, compared to comparative examples.

The present invention can provide an inkjet recording sheet and a manufacturing method thereof which hardly generates cracks at the time of manufacturing as well as is provided with a porous layer being superior in an ink absorptive property, productivity, resistance against creases and cracks, even when a porous layer comprising a hydrophilic binder and micro-particles is coated on a support in a heavy film thickness and at a high speed.

What is claimed is:

1. An ink jet recording medium comprising a support having thereon a porous layer containing micro particles of ground silica and a hydrophilic binder which is cross-linked with ionizing radiation,
wherein the micro particles of ground silica have an average particle diameter of secondary particles of 10-300 nm.

2. The ink jet recording medium of claim 1, wherein the micro particles of ground silica have an average particle diameter of primary particles of 3-50 nm.

3. The inkjet recording medium of claim 1, wherein said micro particles of ground silica is synthesized with a gel method.

4. The inkjet recording medium of claim 2, wherein said micro particles of ground silica is synthesized with a gel method.

5. An ink jet recording medium comprising a support having thereon a porous layer containing micro particles of silica and a hydrophilic binder which is cross-linked with ionizing radiation,
wherein a specific surface area measured with BET method of the micro particles of silica is 40-100 m²/g, and
a coefficient of variation in a primary particle distribution of the micro particles of silica is not more than 0.4.

6. An ink jet recording medium comprising a support having thereon a porous layer containing micro particles of silica and a hydrophilic binder being cross-linked with ionizing radiation,
wherein the micro particles of silica are gas phase method silica, and a ratio of isolated silanol groups of the micro particles of silica is 0.5-2.0.

7. The ink jet recording medium of claim 6, wherein an average particle diameter of primary particles of said gas phase method silica is 5-50 nm, and a ratio of isolated silanol groups of the micro particles of silica is 0.5-1.5.

8. The ink jet recording medium of claim 1, wherein the hydrophilic binder comprises a polymer which is cross-linked by exposing ionizing radiation to a hydrophilic polymer of a degree of polymerization of at least 500, and a main-chain of the hydrophilic polymer having a plurality of side-chains.

9. The ink jet recording medium of claim 5, wherein the hydrophilic binder comprises a polymer which is cross-linked by exposing ionizing radiation to a hydrophilic polymer of a degree of polymerization of at least 500, and a main-chain of the hydrophilic polymer having a plurality of side-chains.

10. The ink jet recording medium of claim 6, wherein the hydrophilic binder comprises a polymer which is cross-linked by exposing ionizing radiation to a hydrophilic polymer of a degree of polymerization of at least 500, and a main-chain of the hydrophilic polymer having a plurality of side-chains.

11. The ink jet recording medium of claim 8, wherein the hydrophilic polymer is an modified polyvinyl alcohol which is capable of cross-linking by ultraviolet ray, and a modification ratio of the side-chain to the main-chain is 0.01-4 mol %.

12. The ink jet recording medium of claim 9, wherein the hydrophilic polymer is an modified polyvinyl alcohol which is capable of cross-linking by ultraviolet ray, and a modification ratio of the side-chain to the main-chain is 0.01-4 mol %.

13. The ink jet recording medium of claim 10, wherein the hydrophilic polymer is an modified polyvinyl alcohol which is capable of cross-linking by ultraviolet ray, and a modification ratio of the side-chain to the main-chain is 0.01-4 mol %.

14. The ink jet recording medium of claim 1, wherein the support is a non water-absorptive support.

15. The ink jet recording medium of claim 5, wherein the support is a non water-absorptive support.

16. The ink jet recording medium of claim 6, wherein the support is a non water-absorptive support.

17. A method for preparing the ink jet recording medium of claim 1, comprising the steps of:
coating on the support an coating composition so as to form a porous layer containing inorganic micro particles and a hydrophilic binder which is capable of cross-linking by ultraviolet ray;
exposing ultraviolet ray to the porous layer by employing a metal halide lamp which has primary emission wavelength of 300-400 nm; and
drying the porous layer,
wherein the ultraviolet ray has an irradiation energy at a wavelength of 350 nm of 1-100 mJ/cm².

18. A method for preparing the ink jet recording medium of claim 5, comprising the steps of:
coating on the support an coating composition so as to form a porous layer containing inorganic micro particles and a hydrophilic binder which is capable of cross-linking by ultraviolet ray;
exposing ultraviolet ray to the porous layer by employing a metal halide lamp which has primary emission wavelength of 300-400 nm; and
drying the porous layer,
wherein the ultraviolet ray has an irradiation energy at a wavelength of 350 nm of 1-100 mJ/cm².

19. A method for preparing the ink jet recording medium of claim 6, comprising the steps of:
coating on the support an coating composition so as to form a porous layer containing inorganic micro particles and a hydrophilic binder which is capable of cross-linking by ultraviolet ray;
exposing ultraviolet ray to the porous layer by employing a metal halide lamp which has primary emission wavelength of 300-400 nm; and
drying the porous layer,
wherein the ultraviolet ray has an irradiation energy at a wavelength of 350 nm of 1-100 mJ/cm².
